(19) United States
(12) Patent Application Publication
(10) Pub. No.: US 2026/0118321 A1
(43) Pub. Date: Apr. 30, 2026

(54) SYSTEMS AND METHODS FOR NONCONTACT NON-DESTRUCTIVE INSPECTION AND DETECTION OF CRACKING IN STRUCTURES

(71) Applicant: University of South Carolina, Columbia, SC (US)

(72) Inventors: LINGYU YU, Columbia, SC (US); ANDREW CAMPBELL, Travelers Rest, SC (US); MST JANNATUL FERDAUSI, Columbia, SC (US)

(73) Assignee: University of South Carolina, Columbia, SC (US)

(21) Appl. No.: 19/371,998

(22) Filed: Oct. 28, 2025

Related U.S. Application Data
(60) Provisional application No. 63/713,444, filed on Oct. 29, 2024.
(60) Provisional application No. 63/729,760, filed on Dec. 9, 2024.

(51) Int. Cl. G01N 29/24; G01N 29/12; G01N 29/46

(52) U.S. Cl. CPC G01N 29/2418; G01N 29/12; G01N 29/2456; G01N 29/46; G01N 2291/0289

(57) ABSTRACT

Non-contact and non-destructive systems and Methods for crack detection that can accurately detect even the smallest cracks and defects such as SCCs in thick materials and structures are disclosed. The systems and methods described herein include a laser ultrasonic inspection system that utilizes guided ultrasonic waves (GUW) for crack inspection and quantification on materials and structures. The systems and methods described herein may include, but are not limited to, a pulsed laser emitter that emits a pulsed laser beam for exciting ultrasonic guided waves propagated into the material or structure to be tested and a scanning Doppler vibrometer take non-contact vibration measurements (i.e., wave motion measurements) of the excited waves within material or structure to be tested. In embodiments, the systems and methods described herein may also include a thin metal material adhered to, attached to, or positioned on the surface of the area of the material or structure to be tested. The systems and methods described herein generate wave images for both area scans and line scans of the test structure and based on the wave images also generate energy map images to identify the presence of cracks and/or defects in the structure/material to be tested.

### CROSS REFERENCE

The present application claims priority to U.S. Provisional Patent Application Ser. No. 63/713,444, filed Oct. 29, 2024, and U.S. Provisional Patent Application Ser. No. 63/729,760, filed Dec. 9, 2024, the contents of which are incorporated herein in their entirety.

### STATEMENT REGARDING FEDERALLY SPONSORED RESEARCH OR DEVELOPMENT

This invention was made with government support under grant no. DE-NE0008959 awarded by the U.S. Department of Energy. The government may have certain rights in the invention.

### FIELD

The disclosure herein is directed to the field of structural and material defect testing, and more specifically for a fully noncontact non-destructive inspection system and method for detecting stress corrosion cracking or similar damage to metal materials and structures.

### BACKGROUND

Stress corrosion cracking (SCC), a hair-like crack, and other similar damage (hereinafter collectively “crack” or “cracks”) is difficult yet important to detect in metal materials and structures. For instance, these cracks have been observed in the high-level nuclear waste tanks that were constructed by welding carbon steel plates, alloy structures in the aerospace industry, bridges, oil, and gas pipelines, etc. Stress corrosion cracking is a safety concern any metal structural component that is subject to both stress and corrosive environmental factors. These cracks need to be detected for safety concerns to prevent leakage and contamination of the surrounding environment and failures of structures.

Various nondestructive methods have been explored for crack detection, such as X-ray inspection, ultrasonic C-scan, Eddy current, and vibration-based methods. However, these methods are limited in efficacy and practicality. Some of these methods are limited to examining an exceedingly small area of the material/structure. Some of these methods require putting the materials to be examined in a water tank or on a shake table. Some of these methods are limited to only examining the surface or near surface of the materials/structures. Further, some of these methods are limited to requiring a low frequency vibration range (<20 kHz) application. None of these limitations are ideal for detecting cracks in larger and thicker materials and make using the above methods impractical for large structures and/or detection in structures outside the laboratory setting.

### SUMMARY

In one general aspect, according to certain embodiments a detection system is disclosed. The system includes pulsed laser emitter (PL), configured to emit a pulsed laser beam, a scanning laser Doppler vibrometer (SLDV), configured to emit a sensing laser beam, and a test structure. The pulsed laser beam is directed to impinge on a front surface of the test structure and the sensing laser beam is directed to impinge on the front surface of the test structure.

In one general aspect, according to certain embodiments a method for noncontact inspection of a structure is disclosed. The method includes configuring a detection system and a test structure, wherein configuring the detection system includes positioning a scanning laser Doppler vibrometer (SLDV) relative to a surface of the test structure and positioning a pulsed laser emitter (PL) relative to the surface of the test structure. The method further includes transmitting a pulsed laser beam from the PL to impinge upon the surface of the test structure and transmitting a sensing laser beam from the SLDV to the surface of the test structure. The method furthermore includes sequentially measuring wave data from multiple points on the surface of the test structure using the SLDV, analyzing, by a processor, the wave data, and generating, by the processor, at least one image of a time-space wavefield based on the wave data. The method moreover includes analyzing, by a processor, the at least one time-space wavefield image and generating, by the processor, at least one energy map image based on the at least one time-space wavefield image.

In embodiments, the systems and methods utilize one or more computers or computing devices which can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

### BRIEF DESCRIPTION OF THE DRAWINGS

FIGS. 1A and 1B illustrate top down and perspective views of the inspection and detection system.

FIG. 1C illustrates scan location 1 and scan location 2 for a normal scan and an in-line scan, respectively, with respect to SCC crack V1 in a test sample.

FIGS. 2A and 2B illustrate a scanning line for a line scan and a scanning area for an area scan, respectively, for a normal scan with respect to an SCC crack in a test sample.

FIGS. 3A and 3B illustrate resultant time-space wavefields from a line scan and an area scan at various time stamps, respectively, in normal inspection.

FIGS. 4A and 4B illustrate a normalized fk spectrum from a line scan and an area scan, respectively, in normal inspection.

FIGS. 5A and 5B illustrate a scanning line for an in-line scan and a scanning area for an area scan, respectively, for an in-line scan with respect to an SCC crack in a test sample.

FIGS. 6A and 6B illustrate resultant time-space wavefields from a line scan and an area scan at various time stamps, respectively, for in-line inspection.

FIGS. 7A and 7B illustrate a normalized fk spectrum from a line scan and an area scan, respectively, in in-line inspection.

FIG. 8 illustrates a flow chart of a method for noncontact inspection and detection of SCC cracks.

### DETAILED DESCRIPTION

In the present description, certain terms have been used for brevity, clearness and understanding. No unnecessary limitations are to be applied therefrom beyond the requirement of the prior art because such terms are used for descriptive purposes only and are intended to be broadly construed. The different systems and methods described herein may be used alone or in combination with other systems and methods. Dimensions and materials identified in the drawings and applications are by way of example only and are not intended to limit the scope of the claimed invention. Any other dimensions and materials not consistent with the purpose of the present application can also be used. Various equivalents, alternatives and modifications are possible within the scope of the appended claims. Each limitation in the appended claims is intended to invoke interpretation under 35 U.S.C. § 112, sixth paragraph, only if the terms “means for” or “step for”are explicitly recited in the respective limitation.

There is an unmet need in the art for a system and method that does not have the shortcomings and limitations of the traditional methods of crack detection that is fully noncontact and non-destructive. There is further an unmet need in art for a system and method of crack detection that can accurately detect even the smallest cracks and defects such as SCCs. SCC cracks are uniquely featured with closed surfaces and hairline shapes and/or dimensions which make them exceedingly difficult to detect using traditional crack detection methods. Additionally, there is further an unmet need in the art for a system and method of crack detection that can detect cracks in larger and thicker materials and structures that may or may not be capable of examination in a laboratory setting. The systems and methods described herein include a laser ultrasonic inspection system that utilizes guided ultrasonic waves (GUW) for crack inspection and quantification on materials and structures. The systems and methods described herein can be used alone for crack detection or may complement the existing methods. The systems and methods described herein provide alternative options for customers that overcome many of the shortcomings of existing methods. The systems and methods described herein can not only inspect an area of a material/structure and detect cracks within the thickness of the material/structure but can also be operated remotely, at higher frequencies, and identify the structure of the crack (e.g., location, length, depth, etc. within the material/structure). In embodiments, the higher frequencies provide for improved detection of smaller dimensioned cracks such as SCCs.

In embodiments, the systems and methods described herein detect cracks in materials and structures including stress corrosion cracks and provide details on the structure of said cracks, including SCCs. As described above, SCC cracks are uniquely featured with closed surfaces and hairline shape and/or dimension. However, the systems and methods described herein can be applied for inspection and detection of more significant cracks such as those resemble a notch cut on the surface, or through-thickness.

The systems and methods described herein may include, but are not limited to, a pulsed laser emitter that emits a pulsed laser beam for exciting ultrasonic guided waves propagated into the material or structure to be tested and a scanning Doppler vibrometer take non-contact vibration measurements (i.e., wave motion measurements) of the excited waves within material or structure to be tested. In embodiments, the systems and methods described herein may also include a thin metal material adhered to, attached to, or positioned on the surface of the area of the material or structure to be tested. In some embodiments, the wave motions are measured in terms of out-plane motion (i.e., normal or perpendicular to the surface of the test structure). In some embodiments, the wave motion measurements can also be measured in terms of in-plane motion (i.e., motions that are parallel to the plane of the surface of the test structure) or both in-plane and out-plane motion. The systems and methods described herein generate images for both normal inspection methods and in-line inspection methods both of which can be for an area scan or for a line scan from a location point on structure/material to be tested. The generated images illustrate the presence of cracks and/or defects in the structure/material to be tested.

In embodiments, the materials and structures to be tested may be any solid structure or material. In embodiments, the materials and structures to be tested may specifically include any metal substance, including thick metal substances up to approximately ½ inch thick. It should be understood that the materials and structures being tested may be thicker than ½ inch thick but the accuracy of the detection at depths greater than ½ inch thick may be degraded.

When the system is activated to detect cracks in a material or structure, the waves from the pulsed laser propagate the material and/or structure. If a crack or defect exists within the material or structure, the waves also propagate the crack and interact with it. In embodiments, the systems and methods described herein use a scanning laser Doppler vibrometer to measure the propagated waves in the structure/material. The scanning laser Doppler vibrometer can generate images for both normal scans and in-line scans both of which can be and area scan for an area on the surface of the structure/material to be tested or a line scan for a location point on structure/material to be tested. In embodiments, another type of laser Doppler vibrometer may be used to measure the waves in the structure. The measured wave data reflects the presence of a crack if one exists, which otherwise would likely be unviewable by the unaided eye. In embodiments, both the pulsed laser and the laser Doppler vibrometer are placed away from the substance being examined. In embodiments, the systems and methods described herein can be conveniently configured and adjusted to accommodate many different test structures regardless of where they are situated without the need to place any equipment (i.e. pulsed laser emitter or laser Doppler vibrometer) on the test structure or place the test structure on equipment. Therefore, once the system is set up different test materials can be swapped in for testing and other than applying the thin metal layer to the test material the system could be remotely operated. Further, if the test structure is not moveable, there is minimal setup required, and the positioning of the equipment is adaptable to different positioning.

The systems and methods described herein can detect not only surface cracks and defects but also cracks and defects within the structure that are unviewable through a visual inspection, including SCCs. Further, the system and method can show the defect profile in the surface plane when post-processing is applied to the images based on how the wave energy distribution is modified by the defect. In embodiments, the system and method can also show the whole dimension of the crack when both surfaces (e.g., the front side and the back side) of the same portion of structure are interrogated and compared. Detection of the crack or defect from both sides may indicate that the defect has penetrated through the thickness of the structure. Accordingly, the systems and methods described herein improve traditional structural inspections by propagating guided ultrasonic waves deep into a structure at high frequences such that even the smallest of cracks (i.e., SCCs) can be detected within the structure. Further the systems and methods described herein can providing imaging of the internal (and external) integrity of the material that makes up the structure.

It should be understood that any laser may be used for the pulsed laser emitter provided the laser is capable of delivering a pulsed laser beam to the structure or material being tested. It should further be understood that equipment similar to a laser Doppler vibrometer capable of measuring the wave motions as explained herein may be used. As particularly discussed herein, the wave motions are measured in terms of out-plane motion (normal to the surface of the plate structure). However, it should be understood that the wave measurement can also be performed for in-plane motion or both in-plane and out-plane motion.

In embodiments, the methods for scanning the materials or structures to be tested include exciting ultrasonic waves within a material or structure to be tested using a pulsed laser beam, systematically traversing areas of the material or structure with the laser beam, receiving wave data in the form of a time-space wavefield image, and generating detailed imaging regarding the material's integrity based on the received wave data. In embodiments, the time-space wavefield may show reflections within in the material or structure. The reflections may indicate the presence of cracks. Furthermore, the presence cracks may impede the propagation of waves past the crack. In embodiments, using the wavefields obtained from the inspection and an energy based imaging method, the systems and methods described herein can generate an image of a crack in addition to identifying the presence of the crack.

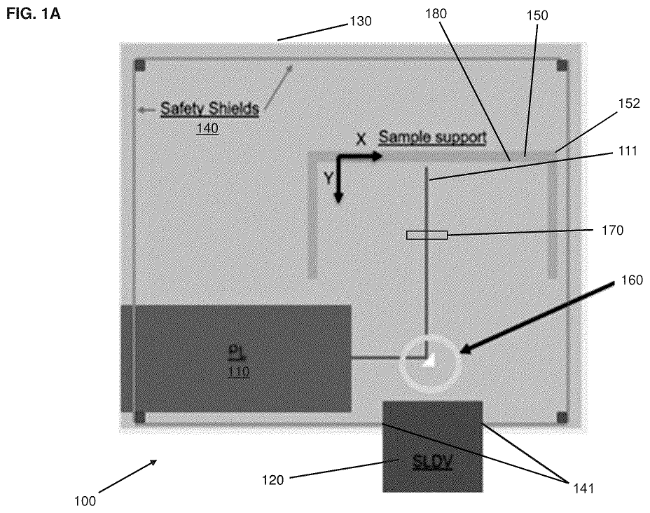

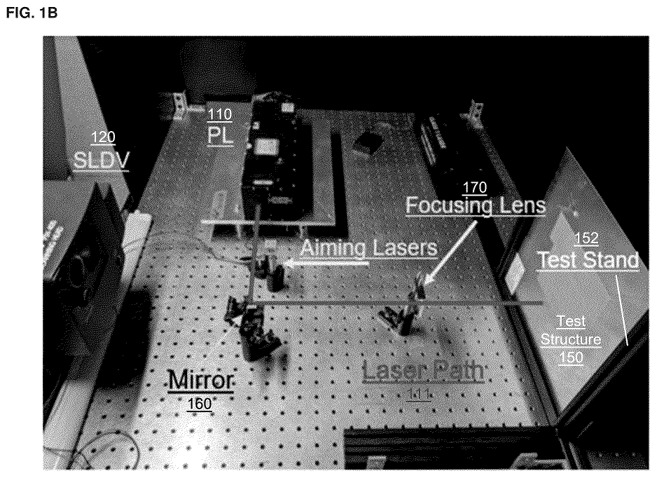

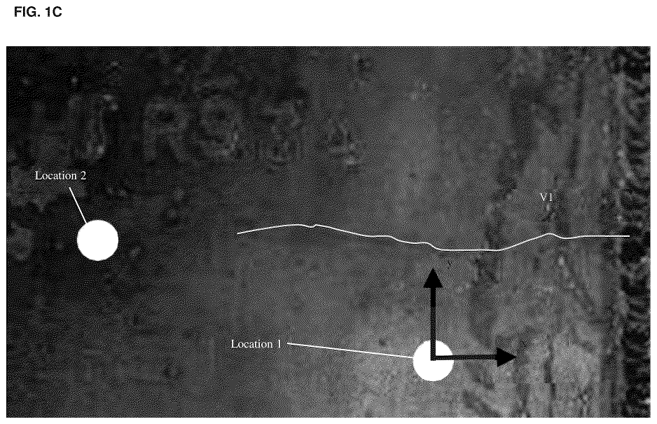

FIGS. 1A and 1B illustrate an example embodiment of a detection system 100 for detecting cracks and defects in structures and materials. It should be understood that the system shown in FIGS. 1A and 1B is merely an example setup of the detection system 100 and such setup should not be considered limiting. As seen in FIGS. 1A and 1B, detection system 100 includes a pulsed laser emitter (PL) 110 and a scanning laser Doppler vibrometer (SLDV) 120 positioned such that the PL 110 can deliver a pulsed laser beam 111 to an area on a test structure 150 and such that the SLDV 120 can measure waves within the test structure 150 excited by the pulsed laser beam 111. The SLDV 120 generates images for normal inspection methods and/or in-line inspection methods for either an area scan and/or for a line scan from a location point on structure/material to be tested. The generated images illustrate the presence of cracks and/or defects in the structure/material to be tested. The PL 110 can be any laser emitter that is capable of transmitting a pulsed laser beam 111 to the test structure 150. In embodiments, the SLDV 120 may be another type of Doppler vibrometer, piezoelectric transducers, phased arrays.

In embodiments, the detection system 100 may further include a thin metal overlay 180 on the surface of the area to be tested of the test structure 150. In embodiments, the thin metal overlay 180 may be any type of metal including, but not limited to aluminum, aluminum-based alloys, nickel-based alloys, copper-based alloys, titanium, niobium, platinum, zinc, or stainless steel. In embodiments, the thickness of the thin metal overly 180 may be between 0.01″ to 0.075″. In embodiments, the size of the thin metal overlay 180 is larger than the profile of the pulsed laser beam 111. In some embodiments, the thin metal overlay 180 is adhered to the surface of the test structure 150. The adhesive may be any typical adhesive used for strain gage such as cyanoacrylate. In some embodiments, the thin metal overlay 180 may be fully adhered to the surface of the test structure 150 such that adhesive fully covers the thin metal overlay 180, may be tacked onto the surface of the test structure 150 such that adhesive only covers the thin metal overly sufficiently for attaching the thin metal overlay 180 to the test structure 150 (e.g., on the corners of the thin metal overlay 180, covering an outer frame of the thin metal overlay 180, etc.), may be placed adjacent to the test structure 150 without adhesive or physical attachment to the test structure 150. It should be further understood that the thin metal overly 180 may be adhered to the test structure 150 through other attachment methods such as tape or other attachment methods. In embodiments including the thin metal overlay 180, the detection system 100 is configured such that the pulsed laser beam 111 impinges on the thin metal overly 180 secured to/against the surface of the test structure 150 rather than impinging directly on the surface of the test structure 150.

In embodiments the detection system may further include a base 130, a laser shielding cabinet 140, and a test stand 152. In embodiments, the PL 110 may be mounted to the base 130. The laser shielding cabinet 140 may enclose the whole base 130 or a portion of the base 130. The test stand 152 may be used to position and hold the test structure 152. Further the test stand 152 may be mounted to the base 130 and/or enclosed within the laser shielding cabinet 140. It should be understood that the specific configuration and appearance of the base 130, laser shielding cabinet 140, and test stand 152 in FIGS. 1A and 1B are merely an example configuration and any or all of these components may or may not be used in the system and may be configured in any way so as to facilitate the detection system 100.

In certain embodiments, the detection system may include a focusing lens 170 and space along the path of the pulsed laser beam 111 about the focusing lens 170. To excite guided ultrasonic waves (e.g., Rayleigh waves) in the test structure 150 in some embodiments it is desirable to intensify the energy of the pulsed laser beam 111 through the use of a focusing lens 170. In embodiments, the focusing lens 170 helps effectively concentrates energy from the pulsed laser beam 111, thereby facilitating greater wave excitation. In embodiments, the focusing lens 170 and thin metal overlay 180 may be used alone or in combination.

In embodiments incorporating the focusing lens 170, the degree of enhancement by the focusing lens 170 is dependent on the energy level employed from the pulsed laser beam 111. Higher energy levels combined with the focusing lens produce a more pronounced effect on the generation of Rayleigh waves in the test structure 150. For example, a wavefield at 105 mJ provided the most distinct information regarding signal quality as compared to 60 mJ and 90 mJ on the example sample test structures when using the focusing lens 170. It is anticipated that a further elevated energy level at 120 mJ will yield even further improved signal quality when using the focusing lens 170.

Depending on the space available for testing and the configuration of the detection system 100 and the placement of the PL 110, one or more high-power threshold reflecting mirrors 160 may be used to redirect the pulsed laser beam 111 at 90° to impinge upon the surface of the test structure 150 or the surface of the thin metal overlay 180 (if being used). In embodiments, the SLDV 120 may be situated to extend through an access aperture 141 of the laser shielding cabinet 140 into the laser shielding cabinet 140. In embodiments, the detection system 100 is configured to increase scanning area of the SLDV 120, allow adjustability for a variety of spatial resolutions, and allow for same side or opposite side testing. In embodiments, the test structure 150 may be moved vertically or horizontally to improve the accessible range of the PL 110 and SLDV 120 to the structure 150. In embodiments, the detection system 100 may be moved around the test structure 150 to improve the accessible range of the PL 110 and SLDV 120.

In embodiments, when configuring the detection system 100, the PL 110 should be positioned such that the pulsed laser beam 111 approaches the test structure 150 as close to normal (90°) as possible but no more than 20 degrees from normal. Additionally, the SLDV 120 should be positioned such that its sensing laser beam (not pictured) the test structure 150 as close to normal (90°) as possible. As indicated above, one or more high-power threshold reflecting mirrors 160 may be used to achieve this desired angle. When the pulsed laser beam 111 and the sensing laser beam from the SLDV 230 approach the test structure 150 at 90°, maximum energy transfer is achieved, and the readings of wave motions by the SLDV 120 are most accurate. It should be understood that angles outside of 90° will work as well, however; the further away from 90° the less energy transferred and also the less accurate the wave motion readings are. In embodiments, by using one or more high-power threshold reflecting mirrors 160 to guide the pulsed laser beam 111, the PL 110 can be maneuvered and impact the test structure 150 at any location without affecting the ability of the SLDV 120 to read the wave motions. The use of one or more high-power threshold reflecting mirrors 160 to guide the pulsed laser beam 111 also enables the SLDV 120 to be placed anywhere (e.g., closer or farther away from the test structure as needed), without potentially interfering with the path of the pulsed laser beam 111 from the PL 110.

In embodiments, the detection system 100 is configured to accommodate same side inspection of the test structure 150 but also providing a convenient re-setting for opposite side inspection of the test structure 150. In embodiments, the configuration of detection system 100 should satisfy the high-power class I/II laser safety requirements. In embodiments for the most accurate detection the pulsed laser beam 111 and the scanning laser beam are directed to impinge on the surface of the test structure 150 (or thin metal overlay 180) at a position properly close to an area of interest on the test structure 150 (i.e., an area suspected of containing a crack or simply the area of the test structure to be tested) as the waves attenuated away quickly as they propagate in thick structures. If the pulsed laser beam 111 and the scanning laser beam impact the test structure at too great of a distance from the area of interest (area to be inspected), interactions with defect may be too weak to be useful for detection. Properly close can mean as close as the scanning area (or scanning line) covering the area where the SCC is suspected having developed, while the pulsed laser excitation may be within 10 mm to 100 mm away from the edge of the scanning area (or scanning line). To ensure the sensing distance, one may test the waves measured at the furthest sensing location possible before the actual inspection to ensure the waves can be propagated that far. In embodiments, while the pulsed laser beam 111 and the scanning laser beam should impact the test structure 150 close to the area of interest (area to be tested), the scanning area of the scanning laser beam should not be too close to the actuation area of the pulsed laser beam 111 such that the interactions with defect may not be discernible from the strong waves close to the wave source (excitation). In embodiments, the pulsed laser beam 111 should be 40 mm-100 mm away from the suspected SCC area (or the line scan area of the portion of the test structure 150 to be tested). It should be understood that the above distances are not limiting, and other distances are contemplated; however, the detection capabilities of the system may be degraded.

Once the components for the detection system 100 are configured and the test structure 150 is provided, the detection system 100 performs an inspection of the test structure 150 and generates images of the excited waves within the test structure 150. The images generated may include normal inspection methods and/or in-line inspection methods both of which can be for an area scan and/or for a line scan from a location point on structure/material to be tested (additional description of these inspections is provided below). The generated images illustrate the presence of cracks and/or defects in the test structure 150, including SCCs. The generated images further enable the detection system 100 to determine details and aspects related to the cracks such that the crack structure (e.g., location, length, depth, etc. within the material/structure) may be determined.

In embodiments, the detection system 100 further includes a computing device(s) (not shown) with one or more processors that have been specially programmed to receive wave data from the SLDV 120 for both area scans and line scans. The computing device(s) is further specially programmed to generate images from the wave data including time-space wavefield images and normalized fk spectrum images. The computing device is further specially programmed to implement a wavefield imaging method that is applied to the wavefield data collected from an area scan and generate an energy map image. In embodiments, the computing device may also be specially programmed to analyze the generated images, including but not limited to the time-space wavefield images, the normalized spectrum images, and the energy map images, to generate an identification of the presence of a crack and dimension information pertaining to the crack, such as length, width, and position within the test structure 150.

The following description provides details regarding the imaging and crack detection generated by the detection system 100. The figures accompanying the description of the imaging and crack detection are merely examples of what the images may look like when a track is detected in a test structure 150. The test structure 150 used in the figures was a test sample with known SCC cracks so that outcomes of the images could be shown. As discussed above, SCC cracks are uniquely featured with closed surfaces and hairline shape and/or dimension. It should be understood that the system can also inspect for and detect more significant cracks such as those resemble a notch cut on the surface, or through-thickness.

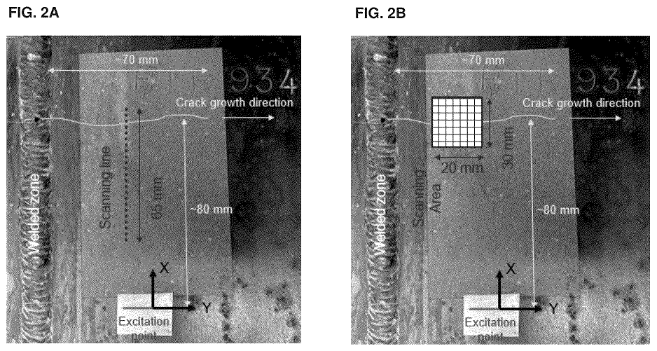

FIGS. 2A & 2B, 3A & 3B, 4A & 4B, 5A & 5B, 6A & 6B, and 7A & 7B illustrate examples of normal inspection scans and in-line inspections scans (including both an area scan and a line scan) with respect to a known SCC crack in the test sample. FIG. 1C illustrates two separate locations on the test sample about which the inspections occur for which the images in FIGS. 2A & 2B, 3A & 3B, 4A & 4B, 5A & 5B, 6A & 6B, and 7A & 7B were generated. As illustrated in FIG. 1C, two inspection locations on the test sample were chosen to demonstrate the crack detection capabilities of the detection system 100. The two locations are the excitation position for the waves, with one location being in line with the SCC and the other location being normal to (in front of) the SCC. It should be understood that these excitation locations are merely examples and were picked specifically to demonstrate the capabilities of the detection system 100. In embodiments, any location on the test structure 150 may be chosen as an excitation location. In embodiments, the location chosen for inspection may be based on surface indications of damage or other known areas of potential structural weakness. In the examples provided, the inspection methods conducted from location 1 and location 2 are referred to as the normal inspection method and the in-line inspection method, respectively. The normal inspection method provides a strong wave-defect scattering effect, causing discernible, classic wave transmission and reflection phenomena. The in-line inspection method shows slight modification to the paths of wave propagation and possible wave trapping along the crack. Both inspection methods are useful in detecting and identifying the features of a crack. Below will describe in more detail the different inspection methods and the example imaging generated based on these methods.

It should be understood that both normal inspection methods and in-line inspection methods employ the same scanning methods as each other for line scanning and area scanning. The difference between the two methods is what is depicted in the resulting images generated from the scans which allow for both the detection of the existence of a crack within the test structure 150 and a determination of whether the scan is depicting an in-line inspection such that the exactment point is parallel to the length of the crack or a normal inspection such that the excitement point is perpendicular to the length of the crack. In the example embodiments illustrated and described below, it is already known what the orientation of the excitement point is to the crack. However, in real world testing, this orientation will likely not be known. Therefore, in real world testing, until it can be determined that there is a crack and what the orientation of the exactment point is to the crack, there will essentially be no difference between a normal inspection method and an in-line inspection method. Only an analysis of the images generated from the scanning will allow for an initial determination of the orientation.

### Normal Inspection

As indicated above, in the examples and figures, the normal inspection method is conducted from location 1 in FIG. 1C. The normal inspection method provides a strong wave-defect scattering effect, causing discernible, classic wave transmission and reflection phenomena. The normal inspection method can be performed both as a line scan or an area scan. FIGS. 2A and 2B illustrate the setup for a normal inspection for a line scan (2A) and an area scan (2B), showing the known crack in the test sample and the scanning line for the line scan and the scanning area for the area scan. As stated above, in the illustrated embodiments, the scans are performed with respect to a known SCC crack in the test sample. However, this should not be considered limiting and is only illustrated on a known SCC crack in a test sample to show efficacy and results of the scans. It should be understood that in most embodiments the location, direction, and existence of cracks is not known, and the scans may not initially align to be perpendicular to the crack (if a crack even exists).

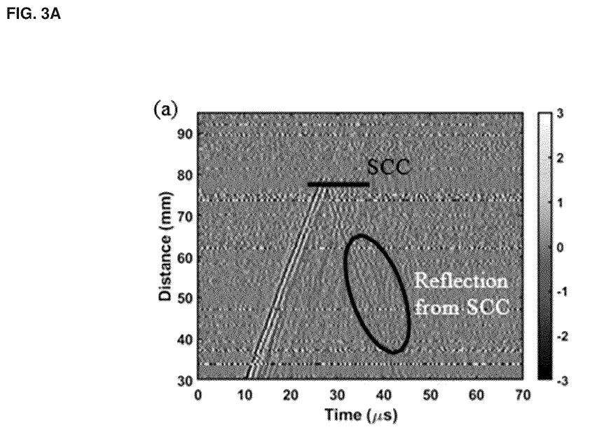

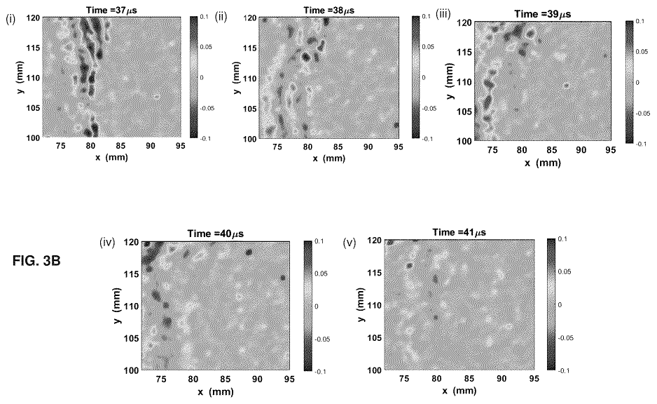

In embodiments, a line scan may be conducted to provide a rapid investigation of the presence and characteristics of cracks within the structure. The normal inspection line scan generates wavefield data that may be depicted as a time-space wavefield image. A crack may exist if the time-space wavefield image of the line scan depicts reflection, which may be caused by the structural discontinuity of the crack. FIG. 3A depicts an example image the measured time-space wavefield from a normal inspection line scan. In embodiments where a crack is detected, the time-space wavefield images may provide clear identification of reflections at certain time and at certain location (from the SCC). In embodiments, an area scan (described below) may be performed when the line scan indicates structural discontinuity. The area scan acquires additional information from the area potentially containing the crack. It should be understood that in some embodiments that the line scan and area scan may be performed in any order and one or the other may not be performed at all.

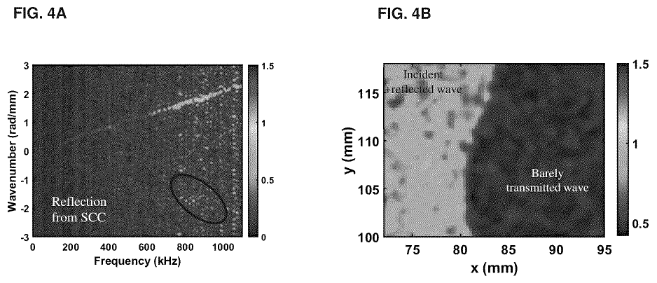

In embodiments, in addition to the wavefield analysis described above and illustrated in FIG. 3A, images of the normalized fk spectrum, shown in FIG. 4A, can also be utilized for the normal in section line scan to further depict reflections resulting from the crack. In embodiments, the normalized fk spectrum image is derived from a two-dimensional Fourier transformation of the wavefield data. This allows for examining the wave phenomena in the frequency-wavenumber domain. This analytical approach is helpful in identifying various wave components and reflections. The fk spectrum image in FIG. 4A depicts a distinct signature. The negative wavenumbers in the lower half of the spectrum represent waves propagating in opposite directions to the inspection waves, which indicate reflections resulting from a structural discontinuity, i.e., the SCC crack, thereby confirming its existence. In embodiments, correlation between the wavefield data and the fk spectrum enhances the reliability of the identification of cracks in a test structure 150, as both methods (time-space wavefield and frequency-wavenumber spectrum) independently point to the same conclusion regarding the crack's influence on wave behavior. This dual analysis not only strengthens the evidence for the presence of reflections but also contributes valuable insights into the interaction between waves and structural defects, which facilitates the disclosed non-destructive evaluation system and techniques.

In embodiments, when the detection system 100 conducts a normal inspection of a test structure 150, and the scan depicts reflection, which may be caused by a crack, the detection system 100 then conducts the area scan to acquire more extensive and detailed information from the area potentially containing the SCC. In embodiments the area scan may be conducted after either wavefield data from the line scan or the fk spectrum from the line scan depicts a crack. It should be understood that either or nor both of the wavefield imaging for the line scan or the fk spectrum imaging for the line scan may be used to determine that an area scan should be conducted. Further it should be understood that an area scan may be conducted without performing any line scans. The area scan is illustrated in FIG. 2B as indicated above.

In embodiments, an area scan may be performed when the line scan indicates structural discontinuity. The area scan acquires additional information from the area potentially containing the crack. It should be understood that in some embodiments that the line scan and area scan may be performed in any order and one or the other may not be performed at all.

An area scan may be performed to generate time dependent wavefield data. In embodiments, time dependent wavefield data is represented as v(t, x), where v represents the SLDV measurement, t represents time, and x is the SLDV measurement point (e.g., excitation location) on the test structure 150. In embodiments, a wavefield imaging method is then applied to the wavefield data collected from the area scan, resulting in an energy map image. When analyzing the generated energy map image, for normal inspection, based on a wave energy perspective, the waves gradually attenuate and decrease as they propagate away from the wave source. When the waves arrive at and interact perpendicular (or near perpendicular) to a crack, distinctive energy distribution change may be depicted in the area before the crack (extensive) and that after the crack (barely any), with a clear boundary in between. This depiction of distribution of energy is consistent with the wave phenomenon and represents the case where the wavefront is normal (perpendicular) to the length of a crack. When the wavefront is normal to the length of the crack, the time lapsed images of an area scan will depict that most of the waves are blocked when they encounter the length of the crack and are reflected with barely any transmitting around the crack. The energy map image for a normal area scan also provides a unique capability to quantitatively evaluate the crack dimension in terms of its length, its indicated width and depth within the test structure as it serves as the barrier to block the waves to move forward through the width of the crack along its length.

In embodiments, for guided wave-based inspection, the waves are ultrasonic wave energy that is propagated through the test structure 150. The propagated waves follow a continuous gradually reduced energy distribution pattern moving away from the source. When a crack is present, the continuous energy distribution pattern will be interrupted. The presence of a crack can be identified through the pattern of wave energy distribution when an energy distribution image is generated. In embodiments, such an energy distribution image can be obtained by using the wavefield v(t, x) from area scan measurement. The wave energy can be generated from quantities such as, but not limited to, the peak amplitude or the root-mean-square value of the waveform acquired at area scan point x. In embodiments, the peak amplitude is selected to represent the energy strength at each point within the area scan of the test structure 150 and assigned as the pixel value, given as:

$${v}_{eng} ( x ) = max \vert v ( t , x ) \vert \qquad ( 1 )$$

The resultant images of the wavefields from this scan are presented in FIG. 3B. During the normal inspection process, the excited guided waves exhibit a strong interaction with the crack leading to a clear depiction of reflected waves. Furthermore, the presence of the crack significantly impedes the propagation of most waves, resulting in minimal transmission beyond the crack. This blockage indicates that the crack not only reflects waves but also acts as a barrier, further underscoring its influence on wave behavior. The analysis of the wavefield results indicate that interactions between the waves and the cracks serve as direct indicators of structural damage.

FIG. 4B further depicts an energy based image generated from wavefields obtained from the normal inspection which illustrate the presence of a crack in the test structure. The imaging generated from normal inspection depict that the waves gradually attenuate and diminish in amplitude as they propagate away from the excitation source, but upon reaching and interacting directly with a crack, a notable change in energy distribution is observed. Specifically, the area preceding the crack displays extensive energy levels, while the region immediately following the crack exhibits minimal energy presence. This distinct contrast indicates a clear boundary between the two areas. Such an energy distribution is consistent with the behavior of waves interacting with a crack when the wavefront is oriented perpendicular to the length of the crack.

In embodiments using the normal inspection, including line scan and/or area scan, if the wavefront is normal to the length of a crack, the majority of the incident waves are obstructed upon encountering the crack, resulting in significant reflection and minimal transmission of energy beyond the crack. The energy map image not only illustrates this interaction but also facilitates the estimation of the crack's shape (particularly the length of the crack and the depth within the interior of the test structure 150).

### In-Line Inspection

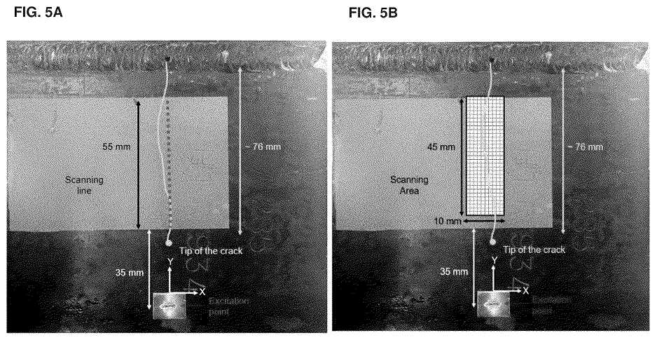

As indicated above, in the examples and figures, the in-line inspection is conducted from location 2 in FIG. 1C. The in-line inspection may be conducted in parallel (“in-line”) to the length of the crack, allowing for the observation of distinct wave-crack interaction phenomena associated with in-line inspection. FIGS. 5A and 5B illustrate the setup for an in-line inspection for a line scan (5A) and an area scan (5B), showing the known crack in the test sample and the scanning line for the line scan and a scanning area for the area scan, respectively. As stated above, in the illustrated embodiments, the scans are performed with respect to a known SCC crack in the test sample. However, this should not be considered limiting and is only illustrated on a known SCC crack in a test sample to show efficacy and results of the scans. It should be understood that in most embodiments the location, direction, and existence of cracks is not known, and the scans may not initially align to be parallel to the crack (if a crack even exists).

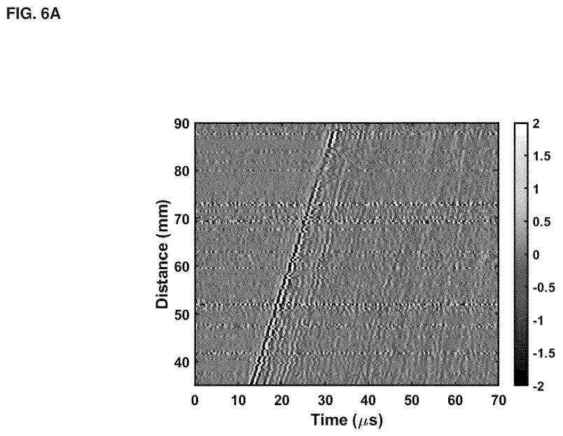

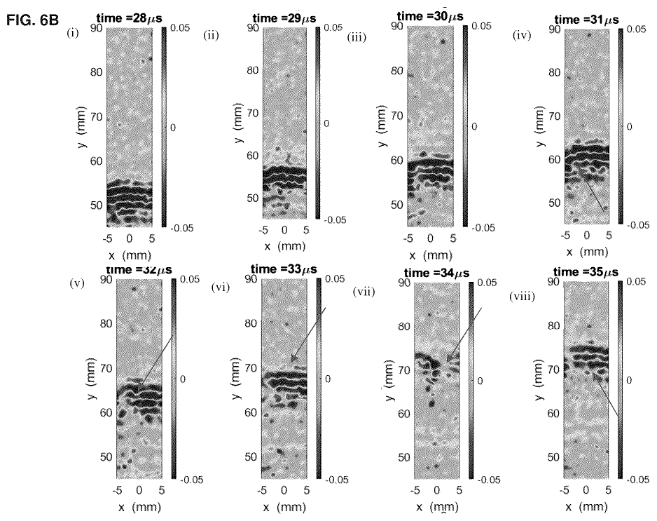

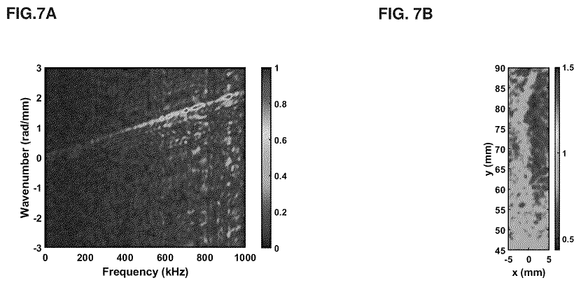

Similar to normal inspection method, in an in-line inspection method a line scan may be first performed. In embodiments, the methods and manner of performing the line scan for the in-line inspection are identical to the normal inspection and images for the time-space wavefield and normalized fk spectrum are generated in the same manner as for normal inspection methods. The difference is the appearance of the images that are generated when the excitement point corresponds to being in-line (parallel) to the length of a crack. FIGS. 6A and 7Aillustrat the image generated from the time-space wavefield data (6A) for the example where the excitement point is in-line with the length of a crack in the test sample and the image generated from the normalized fk spectrum data (7A) for the same example. The images show that the wave intensity, which serves as an indicator of wave energy, is found to increase along the line of the crack. Notably, however, no reflected waves are detected during this inspection, neither in the time-space wavefield nor in the frequency-wavenumber spectrum.

Again, similar to normal inspection, in embodiments for in-line inspection, an area scan may also be conducted. It should be understood that in embodiments the in-line area scan is conducted before or after the in-line line scan. Further, in embodiments the in-line line scan may not be conducted at all. The images of wave propagation generated from an in-line area scan of the test sample with a known SCC are shown in FIG. 6B. As depicted, there is a slight modification of wave propagation patterns after 30 μs in FIG. 6B(iv) to 6B(viii). This modification coincides with the time the wave front arrives or passes through the inspection area based on the wave propagation speed. The area scan data may be further processed and analyzed by the energy based imaging method to evaluate the actual accumulated wave energy in the test structure.

The energy map image shown in FIG. 7B illustrating the SCC is generated using the energy based imaging method using wavefields obtained from the in-line inspection of the test sample. The energy map depicts a clear image of the profile of the SCC crack. Accordingly, in embodiments, the generated energy map may provide a superior imaging of cracks when using the in-line inspection method. In this example, it is illustrated that the incoming waves interacted primarily with the width of the crack rather than its length. In embodiments, as the waves propagate along the length of the crack, a portion of the wave energy may become trapped within the crack. The resulting generated energy map illustrates the wave energy effectively “flowing” through the interior of the crack and down its length. This trapping phenomenon illustrates that the crack not only alters the path of the waves but also influences the distribution of energy within the crack itself. The increased wave intensity along the crack line illustrates that the interaction dynamics are fundamentally different from those observed in the normal inspection.

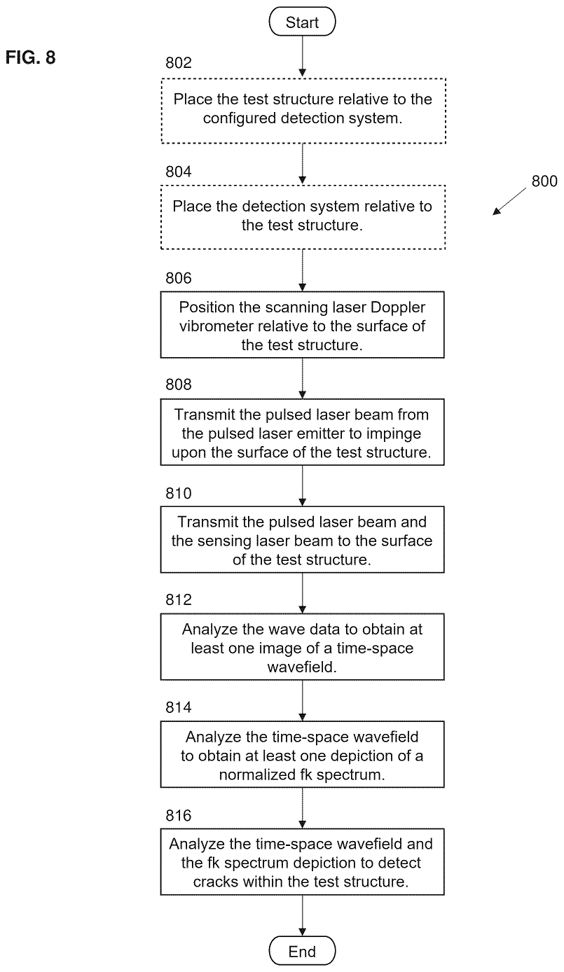

FIG. 8 illustrates a flow chart of a detection method 800 for noncontact inspection and detection of cracks in a test structure 150 using a detection system 100.

In optional block 802, a test structure 150 is placed relative to a configured detection system 100. In embodiments, the detection system 100 may be preconfigured before a test structure 150 is provided and once the test structure 150 is provided it is positioned with respect to the preconfigured detection system 100. In embodiments, the placement of the test structure 150 includes adhering or affixing a thin metal overlay 180 to the surface of the test structure 150. It should be understood that the detection system 100 includes a PL 110 and a SLDV 120 as described above and may include any or none of the additional components described above.

In optional block 804, a detection system 100 is placed relative to a test structure 150. In embodiments, the detection system 100 may be configured around and about a test structure 150 (particularly when the test structure 150 cannot be brought into a laboratory setting for testing). In embodiments, the placement and configuration of the detection system 100 includes adhering or affixing a thin metal overlay 180 to the surface of the test structure 150. It should be understood that the detection system 100 includes a PL 110 and a SLDV 120 as described above and may include any or none of the additional components described above.

In block 806, the SLDV 120 is positioned relative to the surface of the test structure 150 such that the sensing laser beam impinges on the surface of the test structure 150. In embodiments where the surface of the test structure 150 is prepared with the thin metal overlay 180, the SLDV is positioned relative to the surface of the thin metal overlay 180 such that the sensing laser beam impinges on the surface of the thin metal overlay 180. The SLDV 120 is also positioned such that its sensing laser is angled normally (or as close thereto as reasonable) to a surface of the test structure 150 with a clear line of sight to the surface of the test structure 150 or thin metal overlay 180. In embodiments, the SLDV may be positioned relative to a suspected crack within the test structure 150 such that the scan of the sensing laser is in-line with or normal to the suspected crack.

In block 808, the pulsed laser beam 111 is configured to be transmitted from the PL 110 such that the pulsed laser beam 111 will impinge the surface of test structure 150 within 20° of an orthogonal angle to the surface of the test structure 150. In embodiments where the surface of the test structure 150 is prepared with the thin metal overlay 180 the pulsed laser beam 111 is configured to impinge the surface of the thin metal overly 180 within 20° of an orthogonal angle to the surface of the thin metal overlay 180. In embodiments, depending on the configuration of the detection system 100, one or more high-power threshold reflecting mirrors 160 may be incorporated to direct and deliver the pulsed laser beam 111 from the PL 110 to the surface of the test sample 150 or thin metal overlay 180 without interfering with the sensing beam from the SLDV 120. Further, in embodiments a focusing lens 170 may be incorporated along the beam of the pulsed laser beam 111 to focus the pulsed laser beam 111 on the surface of the test structure 150 or surface of the thin metal overlay 180.

In block 810, the pulsed laser beam 111 is transmitted from the PL 110 to the test structure 150 (or thin metal overlay 180) and the sensing laser beam is transmitted from the SLDV 120 to the surface of the test structure 150 (or thin metal overlay 180). The SLDV 120 sequentially measures wave data from multiple points on the surface of the test structure 150 (or thin metal overlay 180). It should be understood that this step is performed the same when conducting either a line scan or an area scan. In embodiments, where a line scan is being conducted the SLDV 120 measures wave data from multiple points along the line to be scanned. In embodiments, where an area scan is being conducted the SLDV 120 measures wave data from multiple points over the area being scanned. It should be understood that block 810 may be repeated if both a line scan and an area scan are being performed one after the other. In embodiments, block 810 is performed for a line scan and then blocks 812-816 are performed, then block 810 is repeated for an area scan and then blocks 812-816 are performed for the area scan. In embodiments, the area scan is performed first, and the line scan is performed after the area scan. In embodiments, only an area scan or a line scan are performed.

In block 812, the wave data is analyzed by a processor of a special purpose computer using a wavefield imaging method. The wavefield imaging method generates at least one image of a time-space wavefield based on the wave data wherein each pixel of the image represents a quantity acquired at each position in the scanning of the test structure 150. The quantity may be selected from measurements such as, but not limited to, the peak amplitude or the root-mean-square value of the waveform.

In block 814, the generated time-space wavefields image(s) is analyzed by a processor of a special purpose computer using a transformation method. The transformation method generates at least one depiction of a normalized fk spectrum, also called an energy map image based on the time-space wavefield image(s). In embodiments, the energy map image may be generated using a two-dimensional Fourier transformation of the time-space wavefield that allows a comprehensive frequency-wavenumber analysis of the wave phenomena.

In block 816, the time-space wavefield images and the energy map images are analyzed by the processor of a special purpose computer to detect the presence of cracks (including SCC cracks) within the scanned area of the test structure 150. Further, if a crack is detected additional scanning and imaging is generated around the area of the detected crack to generate images of the identified crack. The images of the identified crack are analyzed by the processor of the special purpose computer to generate data about the crack including but not limited to the length and width of the crack and the location of the crack within the test structure 150.

It should be understood that while the systems and components of a specialized computer are not fully described herein, the use of a specialized computer is necessary to generating the images described herein and such image generation could not be performed by a human.

It is to be understood that this written description uses examples to disclose the systems and methods describe herein, including the best mode, and also to enable any person skilled in the art to make anew the systems and methods described herein. The various embodiments of the systems and methods described herein may be combined in any arrangement capable of producing the systems and methods described herein. Any dimensions or other size descriptions are provided for purposes of illustration and are not intended to limit the scope of the claimed systems and methods described herein. Additional embodiments can include variations component composition, synthesis, and combination, as well as variations required for use in the industry. The patentable scope of the systems and methods described herein may include other examples that occur to those skilled in the art.

It is to be understood that the following claims are exemplary in nature only, and do not and should not be interpreted to place any limitations on any claims in any subsequent applications whatsoever.

What is claimed is:

1. A detection system, comprising:
pulsed laser emitter (PL), configured to emit a pulsed laser beam;
a scanning laser Doppler vibrometer (SLDV), configured to emit a sensing laser beam; and
a test structure,
wherein the pulsed laser beam is directed to impinge on a front surface of the test structure and the sensing laser beam is directed to impinge on the front surface of the test structure.

2. The detection system of claim 1, further comprising one or more high-power threshold reflecting mirrors.

3. The detection system of claim 2, wherein the one or more high-power threshold reflecting mirrors are positioned to redirect the pulsed laser beam to the surface of the test structure such that the pulsed laser beam and the sensing laser beam arrive at a same surface of the test structure.

4. The detection system of claim 1, further comprising a focusing lens.

5. The detection system of claim 4, wherein the focusing lens is positioned in a path of the pulsed laser beam.

6. The detection system of claim 1, wherein the pulsed laser beam impacts the test sample at an angle of no greater than 20 degrees from normal.

7. The detection system of claim 1, wherein the pulsed laser beam has an energy level between 105 mJ and 120 mJ.

8. The detection system of claim 1, further comprising a thin metal overlay for the surface of the test structure, wherein the pulsed laser beam and the sensing laser beam are directed to impinge on a surface of the thin metal overlay.

9. The detection system of claim 1, wherein the SLDV is positioned so that the sensing laser beam is normal to the test structure surface with a clear line of sight to the structure.

10. A method for noncontact inspection of a structure, comprising:
configuring a detection system and a test structure,
wherein configuring the detection system includes positioning a scanning laser Doppler vibrometer (SLDV) relative to a surface of the test structure and positioning a pulsed laser emitter (PL) relative to the surface of the test structure;
transmitting a pulsed laser beam from the PL to impinge upon the surface of the test structure;
transmitting a sensing laser beam from the SLDV to the surface of the test structure;
sequentially measuring wave data from multiple points on the surface of the test structure using the SLDV;
analyzing, by a processor, the wave data;
generating, by the processor, at least one image of a time-space wavefield based on
the wave data;
analyzing, by a processor, the at least one time-space wavefield image; and
generating, by the processor, at least one energy map image based on the at least one time-space wavefield image.

11. The method of claim 10, wherein the test structure is placed relative to the detection system.

12. The method of claim 10, wherein the detection system is configured around the test structure.

13. The method of claim 10, wherein the SLDV is positioned such that its sensing laser is angled normally to a surface of the test structure with a clear line of sight to the surface of the test structure.

14. The method of claim 10, wherein the SLDV is positioned relative to a suspected crack such that the scan of the sensing laser is in-line with or normal to the suspected crack.

15. The method of claim 10, wherein the pulsed laser beam is transmitted to strike the test sample within 20°of an orthogonal angle.

16. The method of claim 10, wherein the pulsed laser beam and the SLDV laser beam shall be properly close to the area of the test structure to be scanned.

17. The method of claim 10, wherein each pixel of the at least one image of a time-space wavefield represents a quantity acquired at each position scanned in the test structure.

18. The method of claim 17, wherein the quantity is selected from the peak amplitude or the root-mean-square value of the waveform.

19. The method of claim 10, wherein the at least one image of a normalized fk spectrum is derived from a two-dimensional Fourier transform of the time-space wavefield that allows a comprehensive frequency-wavenumber analysis of the wave phenomena.

20. The method of claim 10, wherein configuring the detection system also includes applying a thin metal overlay to the surface of the test structure, positioning the scanning laser Doppler vibrometer (SLDV) relative to a surface of the thin metal overlay, and positioning a pulsed laser emitter (PL) relative to the surface of the thin metal structure;
further wherein a pulsed laser beam from the PL is transmitted to impinge upon the surface of the thin metal overlay and a sensing laser beam from the SLDV is transmitted to the surface of the thin metal overlay; and
further wherein wave data is measured from multiple points on the surface of the thin metal overlay using the SLDV.
